(19) United States
(12) Patent Application Publication
(10) Pub. No.: US 2013/0211897 A1
(43) Pub. Date: Aug. 15, 2013

(54) REAL-TIME MOBILE DEMAND-SHAPING SYSTEM AND METHOD

(71) Applicant: SPEADI, LLC, (US)

(72) Inventors: Michael S. Jaschke, Skillman, NJ (US); Camilla M. Denison, Lake Orion, MI (US); Buford H. Shumaker, Fenton, MI (US)

(73) Assignee: SPEADI, LLC, Fenton, MI (US)

(21) Appl. No.: 13/769,110

(22) Filed: Feb. 15, 2013

Related U.S. Application Data
(60) Provisional application No. 61/599,192, filed on Feb. 15, 2012.

(51) Int. Cl. G06Q 30/02

(52) U.S. Cl. CPC G06Q 30/0267
USPC 705/14.22; 705/14.64; 705/14.44; 705/14.58

(57) ABSTRACT

A demand-shaping server, and method of shaping demand and an infrastructure incorporating the server or the method. In one embodiment, the server includes: (1) a sponsor interface configured to receive from a sponsor information regarding a time-sensitive deal and including a location at which the time-sensitive deal may be claimed and (2) a runner interface coupled to the sponsor interface and configured to transmit notices containing at least some of the information to mobile devices based on runner criteria associated therewith.

### CROSS-REFERENCE TO RELATED APPLICATION

This application claims priority based on U.S. Provisional Application Ser. No. 61/599,192, filed by Jaschke on Feb. 15, 2012, entitled “Real Time Mobile Demand Shaping System,” commonly assigned with this application and incorporated herein by reference.

### TECHNICAL FIELD

This application is directed, in general, to mobile network applications and, more specifically, to a system and method that communicates with mobile devices through a mobile network to communicate business information.

### BACKGROUND

Retail businesses, particularly small retail businesses, face significant challenges. Competent managers and loyal workers are hard to find, competition is relentless, customers are fickle and taxes and regulations are never-ending frustrations.

Other challenges stem from the fact that retail businesses are by nature designed to provide their goods or services at a certain optimal rate. For example, a bakery is designed to turn out an optimal number of loaves of bread per hour, a store has a certain number of feet of shelves designed to hold certain quantities of products without crowding or appearing bare, a restaurant has a certain number of tables, a salon has a certain number of stations, and all of these are provided with certain numbers of point-of-sale terminals (e.g., cash registers) and employees to service customers.

The rate at which retail businesses provide their goods or services may be varied somewhat, as employees may be scheduled to handle time-of-day or seasonal variations, restaurant sections may be opened or closed or machines may be run faster or shut down to accommodate peaks or lulls in business. However, variations from the optimal can significantly impair the profitability of the business, especially when those variations involve disposing of unsold product or when the demand for a more profitable product or service falls short.

Fortunately, retail businesses have devised various techniques to make their volumes more predictable and profitable. By far the most popular is the ubiquitous paper or electronic image coupon, which provides financial incentives to customers to purchase goods or services they might not otherwise. Such financial incentives may be incorporated into a loyalty program, which ranges from the simple punch card (e.g., offering a free cup of coffee upon the purchase of ten donuts) to complex, computer-driven loyalty card programs that track and offer coupons based on customers' buying habits. These devices give retail businesses some ability to shape demand for their products or services and support a multi-billion dollar industry in the United States, indicating that they are here to stay.

### SUMMARY

One aspect provides a demand-shaping server. In one embodiment, the server includes: (1) a sponsor interface configured to receive from a sponsor information regarding a time-sensitive deal and including a location at which the time-sensitive deal may be claimed and (2) a runner interface coupled to the sponsor interface and configured to transmit notices containing at least some of the information to mobile devices based on runner criteria associated therewith.

Another aspect provides a method of shaping demand. In one embodiment, the method includes: (1) receiving from a sponsor information regarding a time-sensitive deal, the information including a location at which the time-sensitive deal may be claimed, (2) transmitting notices containing at least some of the information to mobile devices based on runner criteria associated therewith and (3) receiving responses from the mobile devices indicating intents to claim the time-sensitive deal.

Yet another aspect provides a demand-shaping infrastructure. In one embodiment, the infrastructure includes: (1) a runner criteria database and (2) a demand-shaping server coupled to the runner criteria database. In one embodiment, the demand-shaping server includes: (2a) a sponsor interface configured to receive from a sponsor information regarding a time-sensitive deal and including a location at which the time-sensitive deal may be claimed and (2b) a runner interface coupled to the sponsor interface and configured to: (2b) distribute applications to mobile devices, (2bii) receive runner criteria from the applications, (2biii) store the runner criteria in the runner criteria database and (2biv) transmit notices containing at least some of the information to the applications based on the runner criteria.

### BRIEF DESCRIPTION

Reference is now made to the following descriptions taken in conjunction with the accompanying drawings, in which:

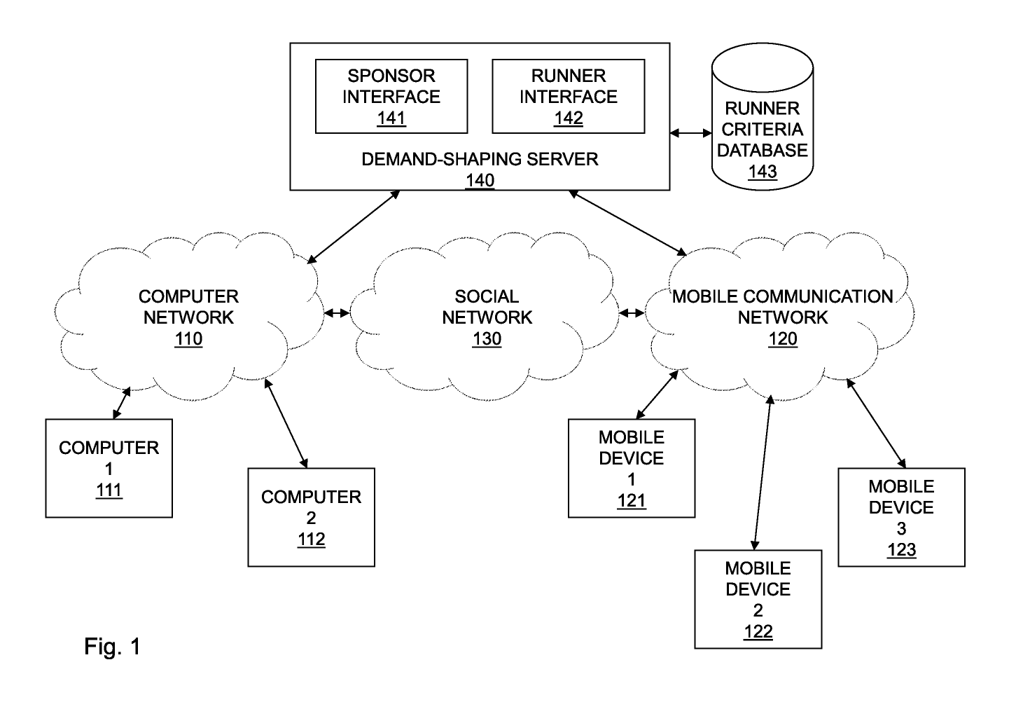

FIG. 1 is a block diagram of one embodiment of a mobile demand-shaping infrastructure;

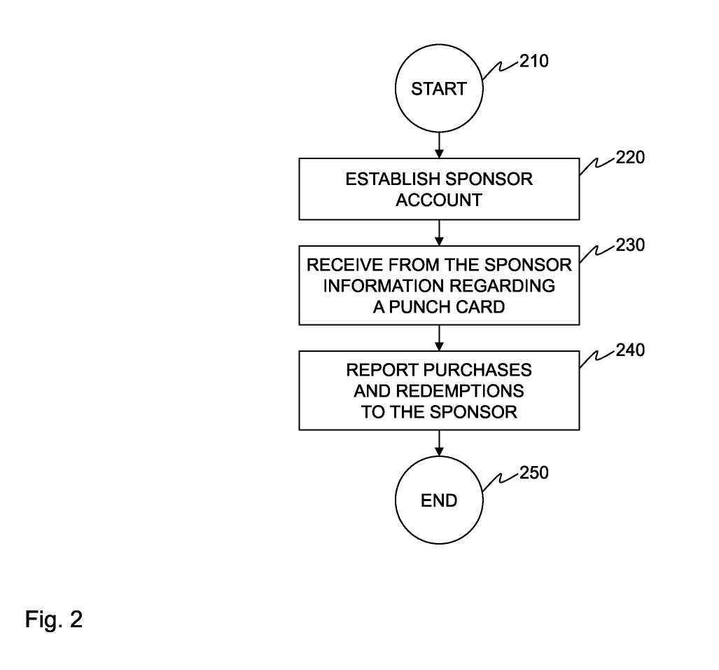

FIG. 2 is a flow diagram of one embodiment of a method of establishing a sponsor account and creating a smart punch-card on the mobile demand-shaping infrastructure of FIG. 1;

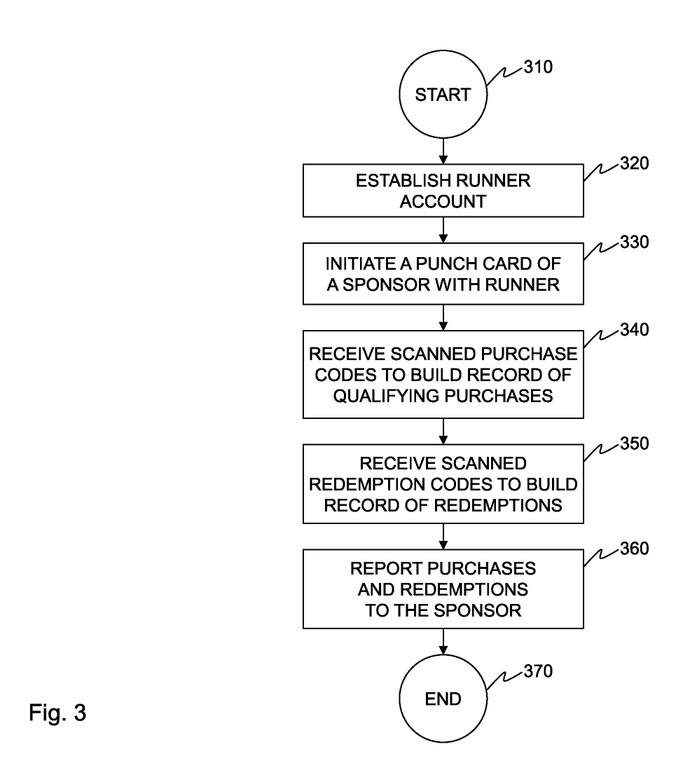

FIG. 3 is a flow diagram of one embodiment of a method of establishing a runner account and accruing purchases on a smart punch-card on the mobile demand-shaping infrastructure of FIG. 1;

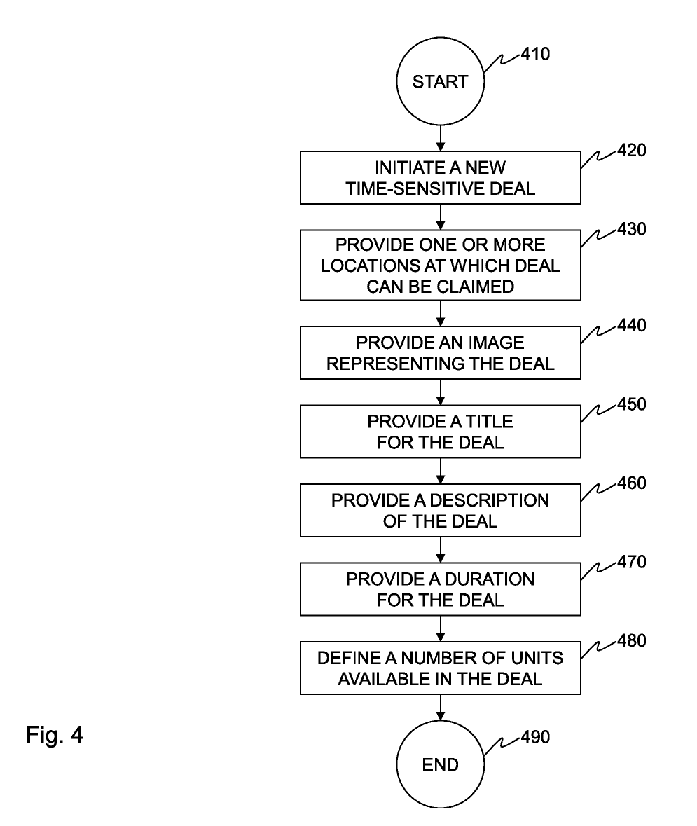

FIG. 4 is a flow diagram of one embodiment of a method of creating a run on the mobile demand-shaping infrastructure of FIG. 1;

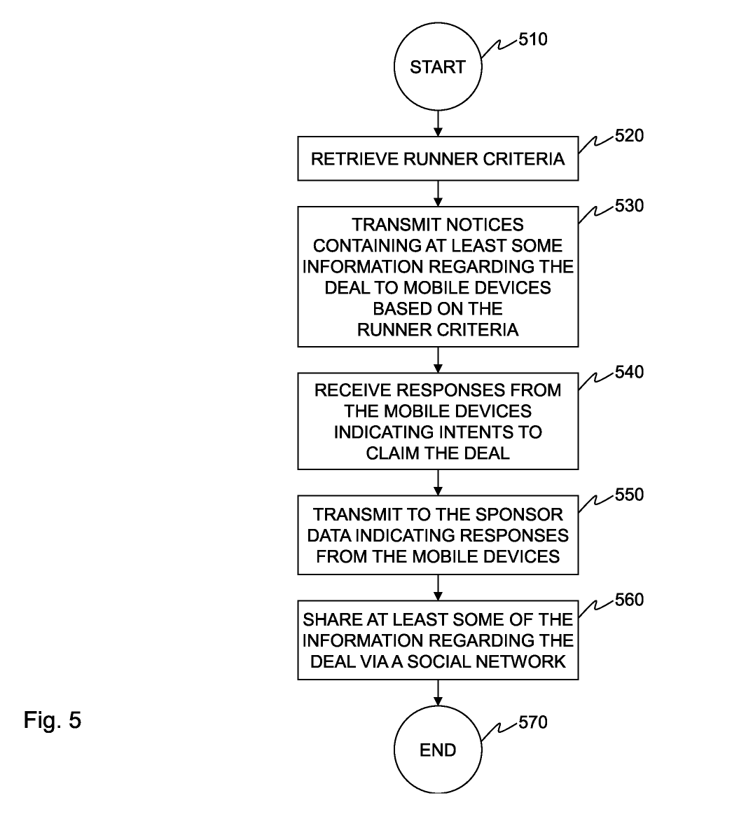

FIG. 5 is a flow diagram of one embodiment of a method of deploying messages on the mobile demand-shaping infrastructure of FIG. 1; and

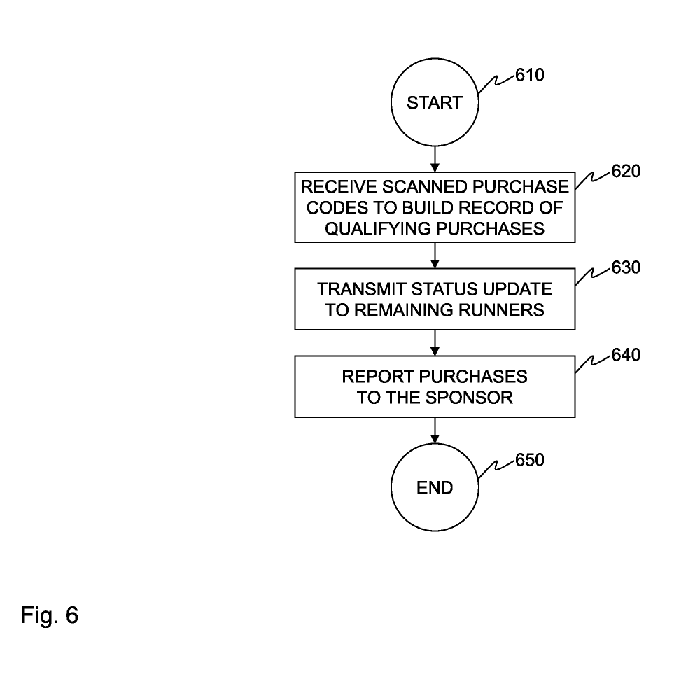

FIG. 6 is a flow diagram of one embodiment of a method of redeeming a run on the mobile demand-shaping infrastructure of FIG. 1.

### DETAILED DESCRIPTION

As stated above, retail businesses use coupons, apart from or as part of a loyalty program, to provide financial incentives to customers to purchase goods or services and thereby shape demand, at least to some degree, for their products or services. However, it is realized herein that coupons and loyalty programs have significant shortcomings.

For example, coupons require time to put in place. Paper coupons must be designed, printed and distributed at the business or by newspaper or physical mail. Electronic coupons must be designed and distributed via a website or email. Designing and distributing coupons takes days at a minimum. Customers also redeem paper coupons at their convenience. They decide when to patronize the business to purchase the pertinent good or service. Consequently, the business' busy times may become busier, and slow times are likely to remain slow. The process of originating and redeeming coupon-based deals is such that they require multi-day lead times and typically involve multiple days over which redemption can occur.

Punch cards share the same disadvantages as paper coupons. However, punch cards are more expensive to print and more likely to be lost, unredeemed or attempted to be redeemed after they have expired, the latter often resulting in serious customer frustration and ill will.

Loyalty programs provide far more insight to businesses regarding their customers' purchasing decisions and accordingly allow the business to personalize deals they offer their customers. Nonetheless, it is realized herein that while loyalty programs tend to increase demand, they have little effect on its timing. Business peaks and lulls persist, and unsold product continues to be wasted. It is further realized herein that the time loyalty programs require to put in place render them ill-suited to mitigate short-term, temporary oversupply (or under-demand). What is needed is a way to “shape” short-term fluctuations in demand.

It is still further realized herein that coupons and loyalty programs fail to instill a sense of urgency in a customer to make a purchase decision. It is realized herein that such programs lack immediacy and are not emotionally engaging, e.g., fun. It is also realized herein that they fail to take full advantage of modern modes of communication and interaction.

Introduced herein are various embodiments of a demand-shaping server and method and an infrastructure incorporating the server or the method. The server, method and infrastructure embodiments provide a mechanism by which a “sponsor,” which is typically a retail business, can originate a “time-sensitive deal” (a deal offered only during a defined time) involving a good or a service to be offered to customers at one or more physical locations (e.g., the business' “bricks-and-mortar” location or locations). The server, method and infrastructure embodiments then cause relevant customers (potential “runners”) to be notified of the existence of the deal via their associated mobile devices (e.g., Smartphones). Customer relevance may be determined by matching the sponsor's deal with criteria the customers have provided in advance. The criteria define the deals about which the customers are interested in being notified. Unlike conventional coupons or loyalty programs, the demand-shaping server, method and infrastructure embodiments are configured to allow a business to tailor deals to create specific demand for specific goods and services over specific, typically small, periods of time (e.g., a few hours of a given day) with very little lead-time (e.g., as short as a few minutes). Consequently, the business can generate a sense of immediacy, urgency, competition and victory for the deals that conventional coupons and loyalty programs have proven over years as being unable to engender.

For example, a barbershop (sponsor) may wish to shape demand to counteract an early-Tuesday-afternoon lull in business (i.e., empty chairs and idle barbers) by launching a 50%-off deal for haircuts only good between the hours of 1 PM and 4 PM that particular Tuesday. The barbershop having defined the deal, the novel server, method or infrastructure embodiments then cause customers who have indicated that they want to be notified of deals from that barbershop to be so notified via their respective mobile devices in accordance with their criteria.

In various embodiments, the locations of the mobile devices relative to the location(s) at which the sponsor is offering the deal are taken into account in determining which mobile devices are sent a notification. For example, in one embodiment, the criteria include a radius within which deals must originate. As a result, customers would be notified based on their proximity to the deal. Distant customers would not be bothered. In other embodiments, all interested customers are notified irrespective of their location, but their mobile devices may not display deals that are too remote from the customer.

In some embodiments, the deal is limited in terms of the number of units of product or service offered. For example, the barbershop could limit the 50%-off deal to the first ten customers who show up at the barbershop. In certain embodiments, the server, method and infrastructure would keep the customers apprised as to how many haircuts have been claimed. Once ten haircuts have been claimed, the deal ends, and notices would likely be sent to customers that the deal is no longer in existence.

In certain embodiments, the customers can respond via their mobile devices by indicating their intent to claim the deal and thereby become runners. For example, eight customers may respond, declaring their intent to claim the deal, i.e., come to the barbershop for a haircut during the defined time. In related embodiments, the server, method and infrastructure then notify the barbershop of the magnitude of the response, perhaps allowing the barbershop to staff accordingly. In various embodiments, runners claim a deal by scanning visual indicia or codes, e.g., a QR code, at the sponsor's place of business, thus notifying the server, method and infrastructure embodiments of the claim. In an alternative embodiment, the sponsor transmits information to the server, method and infrastructure embodiments indicating that a particular runner has claimed the deal.

Those skilled in the pertinent art will realize that the above-described embodiments and example have the potential to create a competition among runners to claim an advantageous deal within the prescribed time. This is an astute observation, and in fact, various embodiments of the server, method and infrastructure include features designed to encourage customers to engage in a race to take advantage of deals. This is why customers are sometimes referred to herein as runners. Some embodiments allow the customers to use their mobile devices to share information regarding a deal via a social network such as Facebook® or Twitter® so news of a deal can be made to propagate to a customer's friends. Other embodiments cause status updates to be provided to customers or their friends regarding the deal. Thus, excitement can build as customers and friends monitor progress toward claiming the deal. Still other embodiments include, as part of the status updates, a runner ranking list for the deal. Again, the sense of competition, and ultimately fun, can be made to build. Yet other embodiments allow the runners to provide feedback to the sponsor regarding the perceived quality of the deal or the excitement of the run to claim it. Accordingly, in these embodiments, responses are received from the mobile devices indicating a rating of the deal.

In still further embodiments, the sponsor can create a punch card via the server, method or infrastructure. In one example, the sponsor can provide information regarding a punch card. The server, method and infrastructure embodiments then can make the information available to the mobile devices. “Punches” accrue as customers make qualifying purchases, and redemption occurs when a qualifying number of purchases are made.

In various embodiments, conventional visual indicia or codes (e.g., a QR code, image or recognizable text) scanning capabilities of a Smartphone are employed to permit customers to download an application that interacts with the server, method or infrastructure, receive deals or punch cards from particular sponsors, claim deals, accrue punches and share updates with friends.

Some embodiments of the novel server, method and infrastructure include financial mechanisms by which the sponsor can pay to establish an account and originate deals and runners can be compensated for referring their friends or recruiting new sponsors to participate, in which case the runners may be regarded as trainers. Related embodiments allow sponsors, runners and trainers to track payments or compensation earned.

Having described various embodiments, reference will now be made to various drawing figures in which example features specific to particular embodiments will be given.

FIG. 1 is a block diagram of one embodiment of a mobile demand-shaping infrastructure. The infrastructure involves a computer network 110, which may be the Internet, and at least one mobile communication network 120, which may be one operated by a telecommunications provider such as AT&T®, Sprint®, Nextel® or any other current or later-arising telecommunications provider. The computer network 110 is illustrated as communicating with a plurality of computers, including a computer 1 111 and a computer 2 112. The computers may be desktop, laptop, notebook, notepad or other conventional or later-developed computer form factors. The computer 1 111 and the computer 2 112 could be mobile devices as well.

The mobile communications network 120 is illustrating as communicating with a plurality of mobile devices, including a mobile device 1 121, a mobile device 2 122 and a mobile device 3 123. The mobile devices may be Smartphones such as Blackberries®, iPhones® and those based on the Android® operating system. In general, the mobile devices are capable of sending and receiving text or multimedia messages and typically include a camera for capturing images such as QR codes.

The infrastructure may include a social network 130, which typically employs the computer network 110 and the mobile communication network 120 as its communication mechanisms and may be Facebook®, Twitter® or any other conventional or later-developed social network.

A demand-shaping server 140 is shown as being in communication with the computer network 110 and the mobile communication network 120 (perhaps directly as shown or via the computer network 110). The demand-shaping server 140 is further shown as being in communication with the social network 130, perhaps via the computer network 110. In general, the demand-shaping server 140 is configured to communicate with the computer 1 111, the computer 2 112, the mobile device 1 121, the mobile device 2 122 and the mobile device 3 123 to effect some or all of the features described above.

In the illustrated embodiment, the demand-shaping server 140 includes a sponsor interface 141. The sponsor interface 141 is configured to receive from a sponsor (communicating, for example, via the computer 1 111 or the mobile device 121) information regarding a time-sensitive deal. The information includes a location at which the time-sensitive deal may be claimed (e.g., the location at which the sponsor conducts business).

In the illustrated embodiment, the demand-shaping server further includes a runner interface 142 coupled to the sponsor interface 141. The runner interface 142 is configured to transmit notices containing at least some of the information regarding the deal to mobile devices (e.g., one or more of the mobile device 1 121, the mobile device 2 122 and the mobile device 3 123) based on runner criteria associated therewith. The runner criteria may include, for example, identities of the sponsors from which the runners are interested in receiving deal or punch-card information, times of the day or days of the week during which the runners are willing to be notified of deals, types of deals of which the runners want to be notified, the content of messages preferred by the runners and deal proximity (i.e., how physically close to a deal the runner wishes to be to be notified).

A runner criteria database 143 is coupled to the demand-shaping server 140. In the illustrated embodiment, the runner criteria database 143 is configured to store the runner criteria received from the runners (e.g., via the mobile device 1 121, the mobile device 2, 122 and the mobile device 3 123. In various embodiments, the runner criteria database 143 is associated with other databases configured to store account information, punch card and deal information, purchase and redemption information and information regarding payments made and received (e.g., by sponsors, to runners or to trainers).

By way of example, a sponsor may contact the demand-shaping server 140 by way of the computer 1 111 and the computer network 110. Through the sponsor interface 141, the sponsor may initiate a sponsor account and a punch card or a time-sensitive deal. Over time, customers contact the demand-shaping server 140 by way of computers (e.g., the computer 2 112) or the mobile devices (e.g., the mobile device 1 121, the mobile device 2 122 and the mobile device 3 123) and the appropriate network (i.e., the computer network 110 or the mobile communication network 120). Through the runner interface 142, they initiate runner accounts and enter runner criteria, which is stored in the runner criteria database 143. As the sponsor initiates a punch card or a deal, the demand-shaping server 140 transmits messages to the pertinent mobile devices based on the runner criteria. As described above, runners can indicate their intent to claim a deal or qualifying punch card purchases by communicating such back to the demand-shaping server 140 via the runner interface 142. Thereafter, the runner interface 142 may send status updates to the runners, and the sponsor interface 141 may send updates regarding a run to the sponsor. Sponsors can likewise transmit punch card redemptions back to the demand-shaping server 140. The sponsor and the runners can also send messages through the social network to alert friends or fans. In one embodiment, the demand-shaping server 140 can send automated messages to the social network 130 as well.

Further detail regarding functions or features of certain embodiments of the server, method and infrastructure will now be set forth with reference to several flow diagrams.

FIG. 2 is a flow diagram of one embodiment of a method of establishing a sponsor account and creating a smart punch-card on the mobile demand-shaping infrastructure of FIG. 1. The method begins in a start step 210. In a step 220, a sponsor account is established. In the illustrated embodiment, a sponsor enters identification information, information regarding its locations and payment information, such as a credit card number. In the illustrated embodiment, the sponsor pays a flat rate for service instead of a fee per punch card or deal. In a step 230, information regarding a punch card is received from the sponsor. The punch card information may include an image, a title and terms and conditions. In a step 240, purchases and redemptions are reported to the sponsor. As stated above, customers may scan one visual indicia, or code, to indicate a purchase and another to indicate a redemption. Alternatively, the sponsor may enter or scan visual indicia, or code, to indicate a redemption. The method ends in an start step 250.

FIG. 3 is a flow diagram of one embodiment of a method of establishing a runner account and accruing purchases on a smart punch-card on the mobile demand-shaping infrastructure of FIG. 1. The method begins in a start step 310. In a step 320, a runner account is established. In the illustrated embodiment, a runner enters identification information and runner criteria, including a notification proximity (for deals) and other notification preferences (e.g., pertaining to the make and model of mobile device the customer uses or times of day or days of week during which the customer is willing to accept notifications). In a step 330, a punch card of a sponsor is initiated with the runner. In the illustrated embodiment, the customer could scan visual indicia, or a code, located in the sponsor's place of business. (A sponsor may, in fact, maintain multiple punch cards concurrently.) In a step 340, scanned purchase codes (indicia) are received over time to build a record of qualifying purchases. In the illustrated embodiment, customers again scan visual indicia or codes to record purchases. It is likely that the sponsor would not publicly display such indicia or codes to ensure that only true purchases are recorded. In a step 350, scanned redemption codes are received over time to build a record of redemptions. In the illustrated embodiment, the sponsor records a redemption. In an alternative embodiment, the customer scans a redemption indicia or code. In a step 360, purchases and redemptions are reported to the sponsor. This gives the sponsor feedback indicating a success or failure of punch cards offered. The method ends in an start step 370.

FIG. 4 is a flow diagram of one embodiment of a method of creating a run on the mobile demand-shaping infrastructure of FIG. 1. The method begins in a start step 410. In a step 420, a new time-sensitive deal is initiated. In a step 430, one or more locations at which deal can be claimed are provided. In a step 440, an image (e.g., a photograph of the sponsor's place of business or the good or service) representing the deal is provided. In a step 450, a title for the deal is provided. In a step 460, a description of the deal is provided. In a step 470, a duration (e.g., expressed in minutes) for the deal is provided. In a step 480, a number of units available in the deal is defined. The method ends in an start step 490.

FIG. 5 is a flow diagram of one embodiment of a method of deploying messages on the mobile demand-shaping infrastructure of FIG. 1. The method begins in a start step 510. In a step 520, runner criteria are retrieved. In a step 530, notices containing at least some information regarding the deal are transmitted to mobile devices based on the runner criteria. In one embodiment, messages are only sent to runners within a certain radius of the location(s) at which the deal is being offered. In an alternative embodiment, messages are sent to all interested customers, but an application executing on the customers' mobile devices causes only those deals within a certain radius to be displayed. In a step 540, responses are received from the mobile devices indicating intents to claim the deal. In a step 550, data indicating responses from the mobile devices are transmitted to the sponsor. In a step 560, at least some of the information regarding the deal is shared via a social network. In one embodiment, runners can also urge their friends to join by establishing their own sponsor or runner accounts. In another embodiment, runners can become trainers and begin to earn money for referring others to join. The method ends in an start step 570.

FIG. 6 is a flow diagram of one embodiment of a method of redeeming a run on the mobile demand-shaping infrastructure of FIG. 1. The method begins in a start step 610. In a step 620, scanned purchase codes (or indicia) are received to build record of qualifying purchases. In a step 630, status update are transmitted to remaining runners. In a step 640, purchases are reported to the sponsor. The method ends in an start step 650.

Those skilled in the art to which this application relates will appreciate that other and further additions, deletions, substitutions and modifications may be made to the described embodiments.

What is claimed is:

1. A demand-shaping server, comprising:
a sponsor interface configured to receive from a sponsor information regarding a time-sensitive deal and including a location at which said time-sensitive deal may be claimed; and
a runner interface coupled to said sponsor interface and configured to transmit notices containing at least some of said information to mobile devices based on runner criteria associated therewith.

2. The server as recited in claim 1 wherein said information includes a number of units of goods or services available in said time-sensitive deal.

3. The server as recited in claim 1 wherein said runner interface is configured to transmit said at least some of said information based on locations of said mobile devices.

4. The server as recited in claim 1 wherein said runner interface is further configured to receive responses from said mobile devices indicating intents to claim said time-sensitive deal.

5. The server as recited in claim 1 wherein said sponsor interface is further configured to transmit to said sponsor data indicating responses from said mobile devices.

6. The server as recited in claim 1 wherein said runner criteria is contained in a runner criteria database associated with said runner interface.

7. The server as recited in claim 1 wherein said runner interface communicates with applications executing on said mobile devices and configured to allow said mobile devices to share said at least some of said information via a social network.

8. The server as recited in claim 1 wherein said runner interface is further configured to provide status updates regarding said time-sensitive deal to said mobile devices.

9. The server as recited in claim 8 wherein said status updates include a runner ranking list for said time-sensitive deal.

10. The server as recited in claim 1 wherein said runner interface is further configured to receive responses from said mobile devices indicating a rating of said time-sensitive deal.

11. The server as recited in claim 1 wherein said sponsor interface is further configured to receive from said sponsor information regarding a punch card and said runner interface is further configured to provide at least some of said information regarding said punch card to said mobile devices and receive data from said mobile devices indicating purchases and redemptions pertaining to said punch card.

12. A method of shaping demand, comprising:
receiving from a sponsor information regarding a time-sensitive deal, said information including a location at which said time-sensitive deal may be claimed;
transmitting notices containing at least some of said information to mobile devices based on runner criteria associated therewith; and
receiving responses from said mobile devices indicating intents to claim said time-sensitive deal.

13. The method as recited in claim 12 wherein said information includes a number of units of goods or services available in said time-sensitive deal.

14. The method as recited in claim 12 further comprising transmitting said at least some of said information based on locations of said mobile devices.

15. The method as recited in claim 12 further comprising causing said at least some of said information to be displayed on said mobile devices based on locations thereof relative to said location at which said time-sensitive deal may be claimed.

16. The method as recited in claim 12 further comprising transmitting to said sponsor data indicating responses from said mobile devices.

17. The method as recited in claim 12 further comprising retrieving said runner criteria from a runner criteria database.

18. The method as recited in claim 12 further comprising communicating with applications executing on said mobile devices and configured to allow said mobile devices to share said at least some of said information via a social network.

19. The method as recited in claim 12 further comprising providing status updates regarding said time-sensitive deal to said mobile devices.

20. The method as recited in claim 19 wherein said status updates include a runner ranking list for said time-sensitive deal.

21. The method as recited in claim 12 further comprising receiving responses from said mobile devices indicating a rating of said time-sensitive deal.

22. The method as recited in claim 12 further comprising:
receiving from said sponsor information regarding a punch card;
providing at least some of said information regarding said punch card to said mobile devices; and
receiving data from said mobile devices indicating purchases and redemptions pertaining to said punch card.

23. A demand-shaping infrastructure, comprising:
a runner criteria database; and
a demand-shaping server coupled to said runner criteria database and including:
a sponsor interface configured to receive from a sponsor information regarding a time-sensitive deal and including a location at which said time-sensitive deal may be claimed, and
a runner interface coupled to said sponsor interface and configured to:
distribute applications to mobile devices,
receive runner criteria from said applications,
store said runner criteria in said runner criteria database, and
transmit notices containing at least some of said information to said applications based on said runner criteria.

24. The infrastructure as recited in claim 23 wherein said information includes a number of units of goods or services available in said time-sensitive deal.

25. The infrastructure as recited in claim 23 wherein said runner interface is configured to transmit said at least some of said information based on locations of said mobile devices.

26. The infrastructure as recited in claim 23 wherein said runner interface is further configured to receive responses from said mobile devices indicating intents to claim said time-sensitive deal.

27. The infrastructure as recited in claim 23 wherein said sponsor interface is further configured to transmit to said sponsor data indicating responses from said mobile devices.

28. The infrastructure as recited in claim 23 wherein said runner interface communicates with applications executing on said mobile devices and configured to allow said mobile devices to share said at least some of said information via a social network.

29. The infrastructure as recited in claim 23 wherein said runner interface is further configured to provide status updates regarding said time-sensitive deal to said mobile devices.

30. The infrastructure as recited in claim 29 wherein said status updates include a runner ranking list for said time-sensitive deal.

31. The infrastructure as recited in claim 23 wherein said runner interface is further configured to receive responses from said mobile devices indicating a rating of said time-sensitive deal.

32. The infrastructure as recited in claim 23 wherein said sponsor interface is further configured to receive from said sponsor information regarding a punch card and said runner interface is further configured to provide at least some of said information regarding said punch card to said mobile devices and receive data from said mobile devices indicating purchases and redemptions pertaining to said punch card.
